(19) United States
(12) Patent Application Publication
(10) Pub. No.: US 2013/0200804 A1
(43) Pub. Date: Aug. 8, 2013

(54) OPERATING UNIT

(71) Applicant: Alexander STOFFEL, Freiburg (DE)

(72) Inventor: Alexander STOFFEL, Freiburg (DE)

(21) Appl. No.: 13/673,884

(22) Filed: Nov. 9, 2012

(30) Foreign Application Priority Data
Nov. 11, 2011 (EP) 11008993.5

(51) Int. Cl. H05B 37/02

(52) U.S. Cl. CPC H05B 37/02
USPC 315/129

(57) ABSTRACT

An operating element for a medical light includes an operating element for setting the size of a light field generated by the light, a screen for displaying the currently set size of the light field and an electronic interface for outputting control signals for the size of the light field to a control device of the light. The operating unit is configured to display a representation of at least one light body of the light, including a light cone emanating from the light body, on the screen and to change the shape of the light cone in the representation correspondingly on an adjustment of the size of the light field by means of the operating element.

The present invention relates to an operating unit for a medical light, in particular for a surgical light or an examination light, having at least one operating element for setting the size of a light field produced by the light at a predefined position and having an electronic interface for outputting control signals for the size of the light field to a control device of the light.

The light field size of a medical light has to be adapted to the respective situation for each operation or examination. Knowledge of the currently set light field size is advantageous for an operator of the light in order e.g. to be able to estimate the remaining size leeway upwardly or downwardly.

There is, however, the problem that a display of the value of the light field size cannot always be detected and classified for the operator at the desired speed. In other words, the controlling of the light field size using a common display requires an increased attention of the operator, which in particular represents a considerable disadvantage with operations to be carried out.

It is therefore an object of the invention to provide an operating unit for a medical light which also enables a reliable and fast operation under stressful conditions.

The object is satisfied by an operating unit having the features of claim 1.

In accordance with the invention, an operating unit includes a screen for displaying the currently set size of the light field and is configured in order, during the operation of the light, to display a representation of at least one illuminant of the light, including a light cone emanating from the light body, on the screen and to change the shape of the light cone in the representation accordingly on an adjustment of the size of the light field by means of the operating element.

The screen therefore, on the one hand, serves for the direct display of the light field size and is additionally used to represent the light body in an exemplary manner and to graphically carry out light field adjustments made by the user in this representation. An operator can detect the current light field size substantially faster and more intuitively due to the screen representation of the light cone varying synchronously with the light field adjustment than is possible only by using numerical displays or scale displays. It is in particular possible to determine fast and without a problem at which point in the range of possible light field sizes the current setting is located. The operator is thus distracted to a lesser degree from the actual operation or examination work, which is particularly of great importance with difficult medical activities.

Further developments of the invention are set forth in the dependent claims, in the description and in the enclosed drawing.

The operating unit is preferably configured to change the shape of the light cone in the representation in real time in each adjustment process. This facilitates the operation of the light to a particular degree. Adjustments of the light field size can e.g. be carried out on a trial basis while observing the representation.

In accordance with an embodiment of the invention, the representation of the light body and of the light cone fills at least 40%, preferably at least 50%, and particularly preferably at least 70% of the total visible height and/or of the total visible width of the screen. A representation of the light body and of the light cone which is as large as possible on the available screen area ensures a good visibility. An operator can in particular also recognize a large-format representation from some distance from the operating unit and under stressful conditions.

In accordance with a further embodiment, the representation of the light body and of the light cone has a height and/or a width of at least 20 mm, preferably of at least 30 mm and particularly preferably of at least 40 mm. A large representation on the screen gives, in comparison with a purely symbolic representation, e.g. in the form of an “icon”, a realistic and quickly ascertainable impression of the state of the “real” light cone of the light.

The representation of the light body and of the light cone can in particular be perspective. This increases the recognizability of the representation and contributes to an improved evaluation of the light field size with reference to the screen representation.

A light field can additionally be displayed in the representation, with the operating unit being configured also to change the size of the light field in the representation accordingly on an adjustment of the size of the light field by means of the operating element.

An embodiment of the invention provides that the screen is touch-sensitive and the operating element is integrated into the screen. The screen can in particular be made as a touch screen. The operating element in this embodiment can in particular be combined with the representation of the light body and of the light cone.

The operating element can in particular be superimposed on the representation of the light body and of the light cone. The representation can therefore extend, e.g. as a background image, over a substantial portion of the screen area, whereas a touch screen field forming the operating element is arranged in the foreground. This provides the advantage of a favorable utilization of the available screen area.

The operating unit can also include an operating element for setting the brightness of a light source of the light, with the operating unit being configured to vary the brightness of the light cone in the representation on the screen accordingly on an adjustment of the brightness of the light source. It can namely be substantially easier for an operator to carry out a brightness change at the represented light cone than at the real operation field or examination field.

The operating unit can furthermore include an operating element for setting the color temperature of a light source of the light, with the operating unit being configured to vary the hue of the light cone in the representation on the screen on an adjustment of color temperature of the light source. Since the color temperature of a light source can be correlated with the hues which can be represented on a screen, this embodiment also makes possible a fast and intuitive ascertainment of the color temperature influence by the operating unit for the user.

An increase in the color temperature from a minimum value to a maximum value is preferably correlated with a change of the hues of the light cone from orange over yellow to white in the representation on the screen. A color temperature of the light source of 4500 K in the representation of the light cone particularly preferably corresponds to a white hue. An operator can then ascertain and evaluate color temperature changes particularly fast since low color temperatures are usually associated with reddish hues and higher color temperatures with white or bluish color temperatures. Daylight has a color temperature of approximately 4500 K. The color impression of the light source corresponding to the color temperature set can generally be produced as exactly as possible while taking account of the representation possibilities of the respective display elements on the screen. Depending on the application, it could, however, also be desired to provide the change of the light cone representation in a more pronounced manner for illustration than corresponds to the change in the color temperature of the light source.

A further embodiment provides that a respective separate operating element is provided for setting the size of a light field produced by the light at a predefined position for setting the brightness of a light source of the light and for setting the color temperature of the light source. This allows a complete control of the light while monitoring the representation of the light body and of the light cone on the screen.

The operating unit can furthermore include an operating element on whose actuation an image is represented on the screen in different sizes, in particular an image of an operating field or examination field produced by a camera. Such a “zoom function” integrated in the screen can provide a surgeon with improved view possibilities. A site of interest of the operating field can be observed on the screen in a desired magnification, for example. To activate the representation of the camera image, a switch element can be provided on whose actuation the screen representation of the light body and of the light cone is faded out and instead the camera image is represented. A larger screen area is then available for the camera image. A switching back to the representation of the light body and of the light cone can also take place via the switch element.

A light exit surface of the light body can furthermore be displayed in the representation which in particular has the same hue as a light field displayed in the representation. The position and detection of the representation can hereby be further facilitated for an operator.

The invention will be described in the following by way of example with reference to the enclosed drawings.

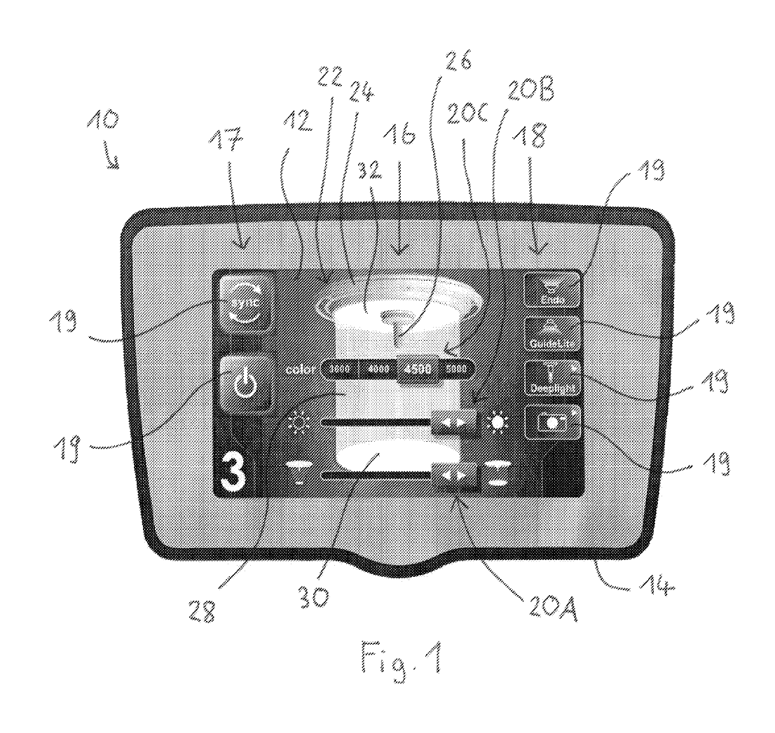

FIG. 1 shows an operating unit in accordance with the invention for an operating light;

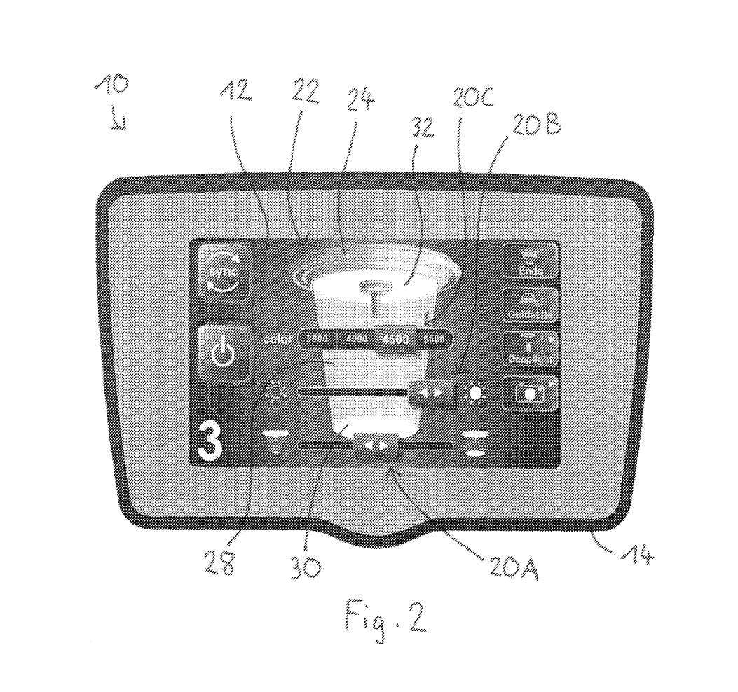

FIG. 2 shows the operating unit of FIG. 1 in a changed setting for the light field size of the operating light;

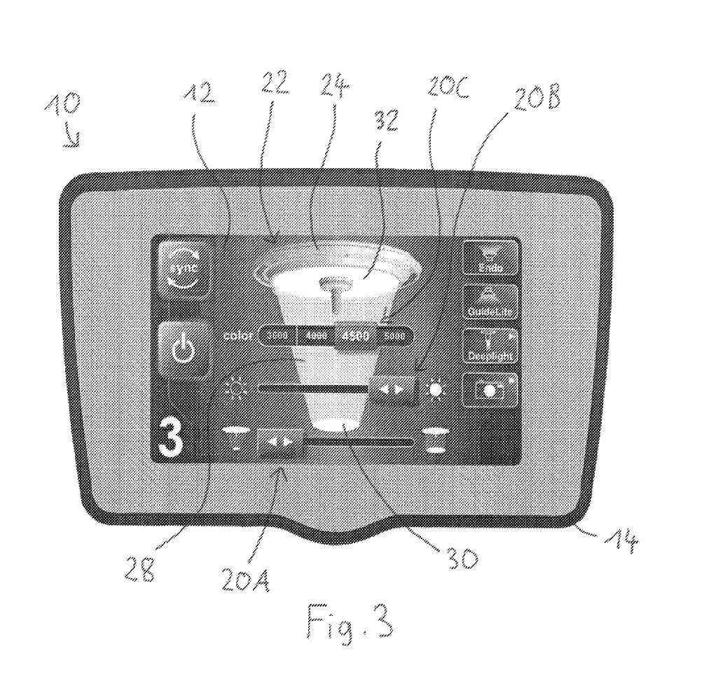

FIG. 3 shows the operating unit of FIG. 1 in a further changed setting for the light field size of the operating light;

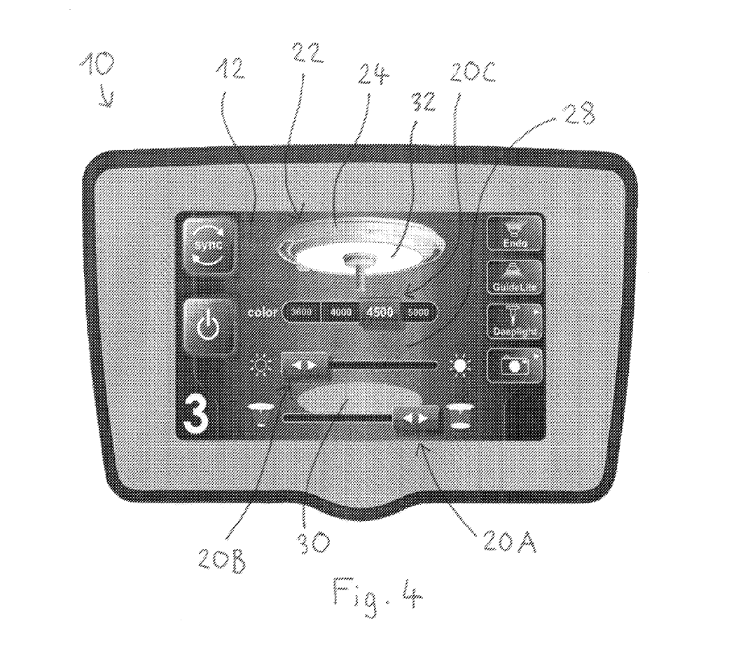

FIG. 4 shows the operating unit of FIG. 1 in a changed setting for the brightness of a light source of the operating light; and

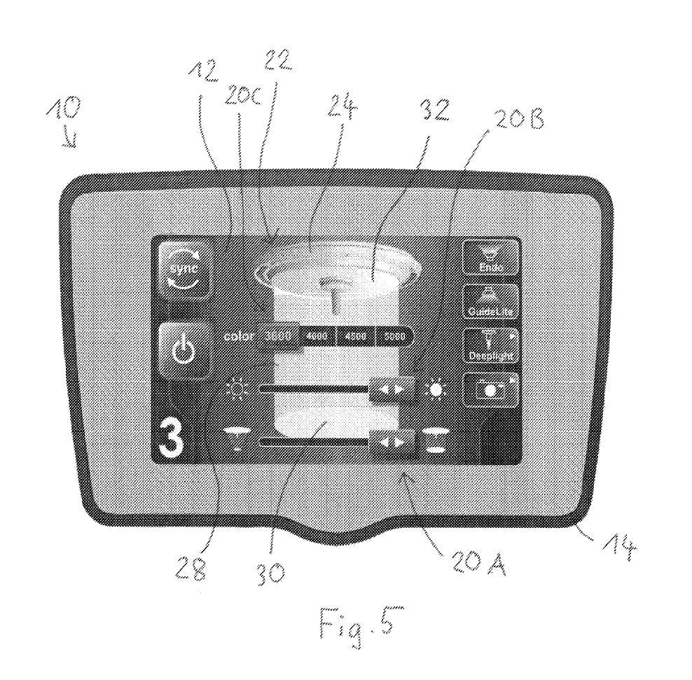

FIG. 5 shows the operating unit of FIG. 1 in a changed setting for the color temperature of a light source of the operating light.

In accordance with FIG. 1, an operating unit 10 for an operating light includes a screen 12 which is designed as a touch screen, which is preferably based on a liquid crystal display or a plasma display and which is accommodated in a housing 14. The housing 14 can be configured for an articulated fastening to a component of the operating light or for a wall installation. The screen 12 is approximately 95 mm wide and approximately 55 mm high and has a central region 16 as well as two lateral regions 17, 18. In the lateral regions 17, 18, a plurality of lateral operating elements 19 are arranged by means of which the operating light can be switched on and off and different additional functions such as a camera image presentation can be activated. In the central region 16, three central operating elements 20A, 20B, 20C are arranged which serve for the control of illumination parameters of the operating light. An electronic interface, not shown, of the operating unit 10 communicates with a plurality of adjustment devices and control devices of the operating light and provides that each setting carried out by the operating elements 19, 20 is implemented by outputting corresponding control signals directly into the associated lighting change at the operating light.

The operating unit 10 moreover includes a video interface, not shown, which is configured for receiving a video signal from an electronic camera. The electronic camera can be integrated in the operating light and can transmit an image of the operating field.

As can be seen from FIG. 1, a light representation 22 is displayed as the background in the central region 16 of the screen 12; it fills approximately 90% of the height of the screen 12 and shows in perspective form a light body 24 of the operating light, including a handle 26, obliquely from below as well as a light cone 28 emanating from the light body 24. The light field 30 produced by the operating light at the predefined operating field as well as the light exit surface 32 of the light body 24 are also displayed in the light representation 22. The three central operating elements 20A, 20B, 20C are superimposed on the light representation 22 and are arranged in the foreground of the central region 16 of the screen 12.

The light representation 22 represents the state of the light cone 28 while taking account of the current settings of the operating elements 19, 20 in a manner close to reality. The operating unit 10 is furthermore configured to adapt the light representation 22 during the operation of the operating light dynamically in real time, as will be explained in more detail in the following with additional reference to FIGS. 2-5.

If an operator of the operating light actuates the lower operating element 20A which is provided for setting the size of the light field of the operating light, not only an adjustment of the real operating light by means of corresponding setting devices is effected, but the shape of the light cone 28 and the size of the light field 30 in the light representation 22 are also changed so that the real changes are made noticeable. An operator can, for example, starting from a maximum light field size in which a parallel light cone 28 is shown in the light representation 22 in accordance with FIG. 1, select a mean light field size by means of the lower operating element 20A. A slightly converging light cone 28 and a smaller light field 30 are then shown in the light representation 22 in accordance with FIG. 2. On a further reduction in the light field size to a minimal value, in accordance with FIG. 3 a clearly converging light cone 28 and a further reduced light field 30 are shown in the light representation 22.

In a similar manner as described above, the brightness of the light cone 28 in the light representation 22 is changed when an operator of the operating light actuates the middle operating element 20B which is provided for setting the brightness of a light source of the operating light. For example, an operator can select a minimal brightness by means of the middle operating element 20B starting from a maximum brightness in accordance with FIG. 1. In accordance with FIG. 4, a light cone 28 darker with respect to FIG. 1, a darker light field 30 and a darker light exit surface 32 are shown in the light representation 22 in accordance with FIG. 4.

When an operator of the operating light actuates the upper operating element 20C, which is provided for setting the color temperature of the light source of the operating light, the hue of the light cone 28 is changed in the light field representation 22—in an analog manner to an adjustment of the light field size and of the brightness. For example, an operator can select a color temperature of 3600 K by means of the upper operating element 20C, starting from a color temperature of 4500 K in accordance with FIG. 1. In accordance with FIG. 5, a light cone 28, a light field 30 and a light exit surface 32 are then shown in a hue redder in comparison with FIG. 1. The upper operating element 20C specifically allows a switching between four different color temperature values. In this respect an orange hue is associated with the value 3600 K, a yellow hue with the value 4000 K and a white hue with the values 4500 K and 5000 K.

The adjustment of the size of the light field, of the brightness and of the color temperature is possible independently of one another, with the light representation 22 being adapted to the changed setting in each individual adjustment. The light cone 28 is e.g. shown brighter when the brightness of the light source is increased by means of the operating element 20B, even if the light field source remains unchanged.

The operator can ascertain the current lighting condition substantially faster by the relatively large-area representation 22 of the light body 24, the light exit surface 32, the light cone 28 and the light field 30, which is updated dynamically and in real time, than if he, for example, first had to locate the desired element from among the three operating elements 20A, 20B, 20C arranged over one another to check the switch position or slider control position thereat.

### REFERENCE NUMERAL LIST:

10 operating unit

12 screen

14 housing

16 central region

17, 18 lateral region

19 lateral operating element

20A, 20B, 20C central operating element

22 light representation

24 light body

26 handle

28 light cone

30 light field

32 light exit surface

1. An operating unit (10) for a medical light comprising
at least one operating element (20A) for setting the size of a light field generated by the light at a predefined position;
an electronic interface for outputting control signals for the size of the light field to a control device of the light; and
a screen (12) for displaying the currently set size of the light field, wherein the operating unit (10) is configured to display a representation (22) of at least one light body (24) of the light, including a light cone (28) emanating from the light body (34), on the screen (12) during the operation of the light and to change the shape of the light cone (28) in the representation (22) correspondingly on an adjustment of the size of the light field by means of the operating element (20A).

2. An operating unit in accordance with claim 1,
wherein the operating unit (10) is configured to change the shape of the light cone (28) in the representation (22) in real time on every adjustment process.

3. An operating unit in accordance with claim 1,
wherein the representation (22) of the light body (24) and of the light cone (28) fills at least 40% of the total visible height of the screen (12).

4. An operating unit in accordance with claim 1,
wherein the representation (22) of the light body (24) and of the light cone (28) fills at least 40% of the total visible width of the screen (12).

5. An operating unit in accordance with claim 1,
wherein the representation (22) of the light body (24) and of the light cone (28) has a height of at least 20 mm.

6. An operating unit in accordance with claim 1,
wherein the representation (22) of the light body (24) and of the light cone (28) has a width of at least 20 mm.

7. An operating unit in accordance with claim 1,
wherein the representation (22) of the light body (24) is perspective.

8. An operating unit in accordance with claim 1,
wherein a light field (30) is furthermore displayed in the representation (22), and wherein the operating unit (10) is configured also to change the size of the light field (30) in the representation (22) accordingly on an adjustment of the size of the light field by means of the operating element (20A).

9. An operating unit in accordance with claim 1,
wherein the screen (12) is touch-sensitive and the operating element (20A) is integrated in the screen (12).

10. An operating unit in accordance with claim 1,
wherein the operating element (20A) is superimposed on the representation (22) of the light body (24) and of the light cone (28).

11. An operating unit in accordance with claim 1,
wherein the operating unit (10) includes an operating element (20B) for setting the brightness of a light source of the light, and wherein the operating unit (10) is configured to change the brightness of the light cone (28) in the representation (22) on the screen (12) accordingly on an adjustment of the brightness of the light source.

12. An operating unit in accordance with claim 1,
wherein the operating unit (10) includes an operating element (20C) for setting the color temperature of a light source of the light, and wherein the operating unit (10) is configured to change the hue of the light cone (28) in the representation (22) on the screen (12) on an adjustment of the color temperature of the light source.

13. An operating unit in accordance with claim 12,
wherein an increase in the color temperature from a minimum value up to a maximum value is correlated with a change in the hue of the light cone (28) from orange over yellow to white in the representation (22) on the screen (12).

14. An operating unit in accordance with claim 12,
wherein a color temperature of the light source of 4500 K in the representation (22) of the light cone (28) corresponds to a white hue.

15. An operating unit in accordance with claim 1,
wherein a respective separate operating element (20A, 20B, 20C) is provided for setting the size of a light field generated by the light at a predefined position, for setting the brightness of a light source of the light as well as for setting the color temperature of the light source.

16. An operating unit in accordance with claim 1,
wherein the operating unit (10) includes an operating element on whose actuation an image is represented in different sizes on the screen (12).

17. An operating unit in accordance with claim 1,
wherein a light exit surface (32) of the light body (24) is furthermore displayed in the representation (22).

18. An operating element in accordance with claim 17,
wherein the light exit surface (32) has the same hue as a light field (30) displayed in the representation (22).
